(19) United States
(12) Patent Application Publication
(10) Pub. No.: US 2001/0033209 A1
(43) Pub. Date: Oct. 25, 2001

(54) Coplanar transmission line

(76) Inventor: Yasunori Ogawa, Tokyo (JP)

Correspondence Address: Venable, P.O. Box 34385, Washington, DC, 20043-9998, US

(21) Appl. No.: 09/838,143

(22) Filed: Apr. 20, 2001

(30) Foreign Application Priority Data
Apr. 21, 2000 (JP) 120218/2000

(51) Int. Cl. H01P 3/08

(52) U.S. Cl. 333/238; 333/246

(57) ABSTRACT

A coplanar transmission line of the present invention comprises a substrate 10, earth-connected conductors 14, 16 formed on the substrate 10, and a center conductor 12 formed between the earth-connected conductors 14, 16. The center conductor 12 includes a lower center conductor 12a and an upper center conductor 12b formed on the lower center conductor 12a. An edge of the upper center conductor 12b is set-back from an edge of the lower center conductor 12a.

### BACKGROUND OF THE INVENTION

The present invention relates to a “coplanar transmission line” for transmitting high-frequency signals of, for example, 1 GHz or more.

Related coplanar transmission lines are disclosed, for example, in pages 34 to 39 of the paper “Monolithic Microwave Integrated Circuits (MMIC), published by the Institute of Electronics, Information and Communication Engineers, in 1997.

FIG. 4 is a cross-sectional view showing a related coplanar transmission line. In FIG. 4, a pair of earth-connected conductors 44, 46, and a center conductor 42 that is between the pair of earth-connected conductors 44, 46 are formed on a dielectric or semiconductor substrate 41 in the same plane. The center conductor and the earth-connected conductors 44, 46 then form a coplanar transmission line.

When a high-frequency signal is inputted to this coplanar transmission line, an electric field occurs between the center conductor 42 and the earth-connected conductors 44, 46, and this electric field is propagated in a lengthwise direction orthogonal to the width-wise direction of the center conductor 42.

The characteristic impedance of the coplanar transmission line is decided by the ratio of a width W of the center conductor 42 and a gap G between the center conductor 42 and the earth-connected conductors 44, 46. This has a substantially proportional relationship with respect to the fixed characteristic impedance, and the gap G becomes small if the width W of the center conductor 42 is made small.

There are, however, cases where a high-frequency signal and a direct current flow in the center conductor when this coplanar transmission line is applied to a Monolithic Microwave Integrated Circuit (MMIC). Metals with superior conductivity and which provide good electromigration are employed as the material for the conductors to ensure that a substantial direct current flows in an effective manner. Further, it is typical for resistance of a conductor to be made to fall by forming a thick conductor so as to maintain current carrying capacity.

However, when the conductor is formed thickly, the cross-sectional shape of the conductor is trapezoidal or reverse trapezoidal, and build-up, etc., occurs at the edge portions, so that it is difficult to form the cross-section in a rectangular shape in an accurate manner. In order to make the MMIC chip size small, it is necessary to make the width W of the center conductor and the gap G as small as possible, but the influence this has on the cross-sectional shape of the conductor cannot be ignored.

When a conductor is thickly formed, current carrying capacity with respect to the direct current can be ensured but, on the other hand, it is difficult to ensure that high-frequency signals flow as designed.

### SUMMARY OF THE INVENTION

In order to resolve the aforementioned problems, a coplanar transmission line of the present invention comprises a substrate, a pair of earth-connected conductors formed on the substrate, and a center conductor formed between the earth-connected conductors. The center conductor consists of a lower center conductor and an upper center conductor formed on the lower center conductor. An edge of a pattern for the upper center conductor is set back from an edge of the lower center conductor.

### BRIEF DESCRIPTION OF THE DRAWINGS

FIG. 1 is a cross-sectional view of a first embodiment of a coplanar transmission line of the present invention.

FIG. 2 is a graph showing the relationship between a set-back distance d of the edge of the upper center conductor and the impedance in the coplanar transmission line of the present invention.

FIG. 3 is a cross-sectional view of a second embodiment of a coplanar transmission line of the present invention.

FIG. 4 is a cross-sectional view of a related coplanar transmission line.

### DESCRIPTION OF THE PREFERRED EMBODIMENT

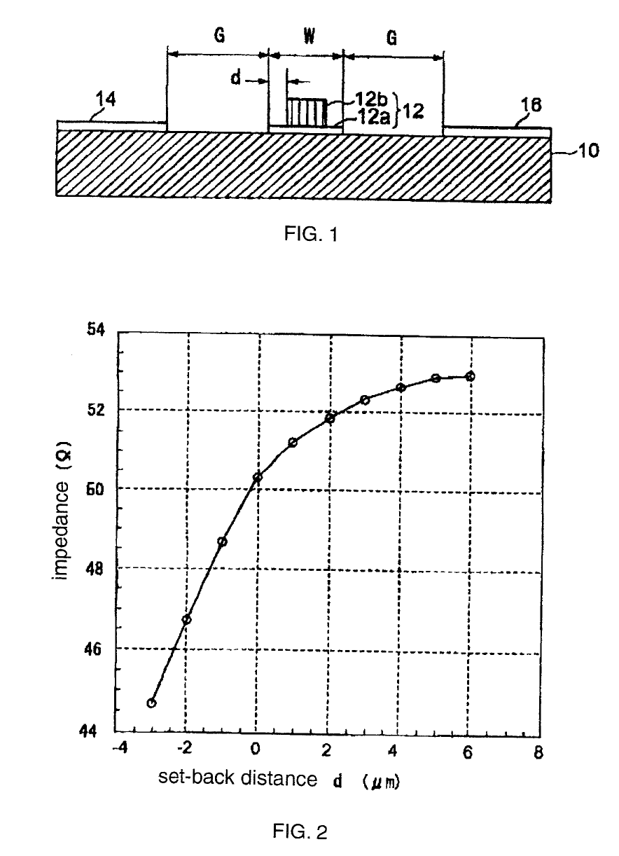

FIG. 1 is a cross-sectional view showing a first embodiment of a coplanar transmission line of the present invention. In FIG. 1, a coplanar transmission line comprises a pair of earth-connected conductors 14 and 16 formed on a substrate 10 of a dielectric or a semiconductor, with a center conductor 12 being formed therebetween.

The center conductor 12 consists of a lower center conductor 12a and an upper center conductor 12b formed on the lower center conductor 12a. In the cross-sectional view of FIG. 1, the width of the upper center conductor 12b is formed so as to be set-back by a length d from both sides with respect to the width W of the lower center conductor 12a, i.e. the edge of the pattern of the upper center conductor 12b is set-back just a distance d from the edge of the pattern for the lower center conductor 12a.

A method for manufacturing a coplanar transmission line structured in this manner will now be described with reference to FIG. 1. First, as primary interconnect, a pair of earth-connected conductors 14, 16 and a stripe-shaped lower center conductor 12a formed between the earth connected conductors 14, 16 are formed as thin films on the GaAs substrate 10 of a thickness of 600 μm using normal deposition and lift off technology.

The material for this primary interconnect is, for example, gold (Au), and is formed to a thickness of approximately 0.7 μm. A thickness of 0.7 μm for each conductor formed by this primary interconnect provides a thickness sufficiently thicker than the skin depth of 0.45 μm for the lower limit of milliwaves, for example 30 GHz. The width W of the lower center conductor 12a is 20 μm, and the gaps G with the earth-connected conductors 14 and 16 are taken to be 20 μm, respectively.

Next, an upper center conductor 12b is formed on the lower center conductor 12a as secondary interconnect using plating technology. Gold (Au) is used as the material for this secondary interconnect and is formed by plating to a thickness of approximately 3 μm.

The width of the upper center conductor 12b is taken to be 14 μm so as to be set-back by just a length of d (3 μm) from both ends compared with the width (20 μm) of the lower center conductor 12 a. The upper center conductor 12b formed by the secondary interconnect is electrically connected to the lower center conductor 12a so as to conduct.

With the coplanar transmission line of the configuration shown in FIG. 1, the relationship between a length d (set-back distance d) from the edge of the lower center conductor 12a to the edge of the upper center conductor 12b and the impedance can be analyzed using simulation. FIG. 2 is a graph showing the results of a simulation for a frequency of 77 GHz.

In FIG. 2, inclination is substantial when d>0, i.e. when the pattern of the upper center conductor 12a is broader than the pattern of the lower center conductor 12b. It is therefore possible that there may be substantial fluctuations in impedance when inconsistencies occur in the length d during actual manufacture.

The case when d=0, i.e. the case where the patterns for the lower center conductor 12a and the upper center conductor 12b overlap, is the same as the case for where d<0. The case where d=0 is the same as the case where the conductor thickness =3.7 μm with a related coplanar transmission line structure. With a coplanar transmission line of the related structure, it can be inferred that the cross-sectional shape of the conductor can have a substantial effect on the characteristics because the inclination of the graph in the vicinity of d=0 is substantial.

On the other hand, in the region where d>0, the inclination of the graph reduces gradually, and approaches substantially zero in the vicinity of d=6 μm (twice the thickness of the upper center conductor).

From the above, theoretically, when the value for the set-back distance d is made to be 6 μm, when d is made too large, the cross-sectional area of the upper center conductor 12b becomes small, and a sufficient direct current carrying capacity cannot be obtained. In this embodiment, the characteristic of the coplanar transmission line is stabilized by setting the value of the set-back distance d to 3 μm, which is the thickness of the upper center conductor, and an increase in the direct current carrying capacity can be obtained.

For example, change in impedance is kept down to 0.3 Ω even for a precision error for the pattern of the upper center conductor 12b of 1 μm, due to the influence of the shape of the edge, etc. Further, direct current carrying capacity is proportional to the cross-sectional area of the conductor. The cross-sectional area of the upper center conductor 12b formed by the secondary interconnect is 42 μm² compared to the 14 μm² for the cross-sectional area of the lower center conductor formed by the primary interconnect, and therefore can ensure three times the current carrying capacity.

In the manner described above, direct current carrying capacity is ensured and stability of the coplanar high-frequency characteristic is improved by adopting a multi-layer structure for a center conductor constituting the coplanar transmission line and by having the width of the pattern for the upper center conductor set-back from the pattern for the lower center conductor.

MMICs normally require crisscrossing interconnects and therefore have multi-layer interconnect structures and the providing of the secondary interconnect therefore does not necessitate any further manufacturing steps. The lower center conductor and the upper center conductor may have single or multi-layer structures.

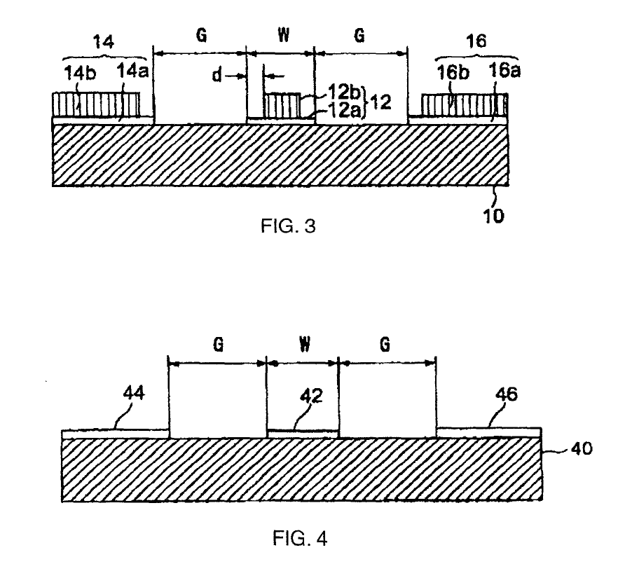

Next, a description is given of a second embodiment of a coplanar transmission line of the present invention using FIG. 3.

In FIG. 3, a coplanar transmission line differs from the first embodiment in that, in addition to the center conductor being comprised of a lower conductor and an upper conductor, the earth-connected conductors also comprise lower earth-connected conductors and upper earth-connected conductors. Other aspects of this embodiment are the same as for the first embodiment, with the same configurational elements being given the same reference numerals.

In FIG. 3, a coplanar transmission line comprises a pair of earth-connected conductors 14 and 16 formed on a substrate 10 of a dielectric or a semiconductor, with a center conductor 12 being formed therebetween.

The center conductor 12 consists of a lower center conductor 12a and an upper center conductor 12b formed on the lower center conductor 12a. One of the earth-connected conductors 14 comprises a lower earth-connected conductor 14a and an upper earth-connected conductor 14b formed on the lower earth-connected conductor 14a. Another earth-connected conductor 16 comprises a lower earth-connected conductor 16a and an upper earth-connected conductor 16b formed on the lower earth-connected conductor 16a.

The width of the upper center conductor 12b is formed so as to be set-back by a length d from both sides with respect to the width W of the lower center conductor 12a, A gap G side for the upper earth-connected conductors 14b and 16b is set-back from the lower earth-connected conductors 14a and 16a. It is also possible to set-back the pattern only on the side of the gap G that influences the coplanar characteristics and not have any setting back on the side opposite to the gap G.

A method for manufacturing a coplanar transmission line structured in this manner will now be described with reference to FIG. 3. First, the pair of lower earth-connected conductors 14a and 16a, and a stripe-shaped lower center conductor 12a located between the earth-connected conductors 14a and 16a are formed as thin films as primary interconnect on a substrate 10 comprised of GaAs.

Next, an upper center conductor 12b is formed on the lower center conductor 12a as secondary interconnect using plating technology. At the same time, the upper earth-connected conductors 14b and 16b are formed on the pair of lower earth-connected conductors 14a and 16a, respectively.

The upper center conductor 12b formed by the secondary interconnect is electrically connected to the lower center conductor 12a so as to conduct. The upper earth-connected conductor 14b formed from the secondary interconnect conducts electrically with the lower earth-connected conductor 14a, and the upper earth-connected conductor 16b conducts electrically with the lower earth-connected conductor 16a.

With normal coplanar transmission lines, the pattern of the earth-connected conductors is sufficiently broad compared with the center conductor and current carrying capacity of the earth-connected conductor generally does not present any problem. However, there are cases where the patterns for the earth-connected conductors cannot be formed sufficiently broadly due to design limitations. In such cases, not just the center conductor but also the earth-connected conductor can be comprised of a lower conductor and an upper conductor.

According to the coplanar transmission line of the second embodiment, in addition to ensuring direct current carrying capacity of the center conductor, direct current carrying capacity of the earth-connected conductors can also be guaranteed.

As described above, according to the coplanar transmission line of the present invention, the center conductor is comprised of a lower conductor and an upper conductor, and the edge of the pattern for the upper center conductor is set-back back from the edge of the pattern for the lower center conductor. As a result, direct current carrying capacity can be guaranteed and stability of the high-frequency characteristic can be improved.

What is claimed is:

1. A coplanar transmission line comprising:
a substrate;
a pair of earth-connected conductors formed on the substrate; and
a center conductor formed between the earth-connected conductors,
wherein the center conductor comprises a lower center conductor pattern and an upper center conductor pattern formed on the lower center conductor pattern, and an edge the upper center conductor pattern is set-back from an edge of the lower center conductor pattern.

2. The coplanar transmission line of claim 1, wherein both edges of the upper center conductor pattern are set-back from the edges of the lower center conductor pattern.

3. The coplanar transmission line of claim 2, wherein an edge of the upper center conductor pattern is set-back from an edge of the lower center conductor pattern by a distance equal to or greater than the thickness of the upper center conductor.

4. The coplanar transmission line of claim 3, wherein said substrate comprises GaAs.

5. The coplanar transmission line of claim 1, wherein the upper center conductor pattern comprises an Au layer.

6. The coplanar transmission line of claim 1, wherein said earth-connected conductors respectively comprise lower earth-connected conductors and upper earth-connected conductors formed on the lower earth-connected conductors, and edges of the upper earth-connected conductors are set-back from the edges of the lower earth-connected conductors.

7. The coplanar transmission line of claim 6, wherein the edge of the upper earth-connected conductor is set-back from the lower earth-connected conductor by a distance equal to or greater than the thickness of the upper earth-connected conductor.

8. The coplanar transmission line of claim 6, wherein the upper earth-connected conductor comprises an Au layer.

9. A coplanar transmission line formed on a substrate, comprising:
a plurality of peripheral conductors formed on the substrate, said peripheral conductors are electrically connected to the ground; and
a center conductor formed on the substrate between the peripheral conductors, said center conductor including,
a lower center conductor formed on the substrate, the lower center conductor having an edge and
an upper center conductor formed on the lower center conductor, the upper center conductor having an edge located inside of the edge of the lower center conductor.

10. A coplanar transmission line according to claim 9, wherein the upper center conductor pattern has both edges located inside of the lower center conductor pattern.

11. A coplanar transmission line according to claim 9, wherein the edge of the upper center conductor pattern is located from the edge of the lower center conductor pattern by a distance equal to or greater than a thickness of the upper center conductor pattern.

12. A coplanar transmission line according to claim 9, wherein the substrate includes gallium and arsenic.

13. A coplanar transmission line according to claim 9, wherein the upper center conductor pattern includes a gold layer.

14. A coplanar transmission line according to claim 9, wherein said peripheral conductors includes lower peripheral conductors and upper peripheral conductors formed on the lower peripheral conductors.

15. A coplanar transmission line according to claim 14, wherein the upper peripheral conductors have edges located inside of the lower peripheral conductors.

16. A coplanar transmission line according to claim 14, wherein each of the edges of the upper peripheral conductors is located inside from the lower peripheral conductor by a distance equal to or greater than a thickness of the upper peripheral conductors.

17. A coplanar transmission line according to claim 14, wherein each of the upper peripheral conductors includes a gold layer.
